(19) United States
(12) Patent Application Publication
(10) Pub. No.: US 2011/0069404 A1
(43) Pub. Date: Mar. 24, 2011

(54) DETACHABLE MAGNIFIER APPARATUS

(76) Inventor: Peter J. Lappin, Beverly, MA (US)

(21) Appl. No.: 12/736,884

(22) PCT Filed: May 18, 2009
(86) PCT No.: PCT/US2009/003093

§ 371 Date: Nov. 18, 2010

Related U.S. Application Data
(60) Provisional application No. 61/128,112, filed on May 19, 2008.

(51) Int. Cl. G02B 25/00; G02B 7/02; G02B 27/02

(52) U.S. Cl. 359/818; 359/811

(57) ABSTRACT

A simple and inexpensive magnifying apparatus is removably attachable to most any type of electronic device (30) having a display screen (32) containing information to be viewed by a user of the electronic device. The apparatus has an element that connects (42) a magnifying element (90) to an element that removably attaches (44, 96, 108) to the electronic device, where the device permits the magnifying element to be moved into and out of position over the display screen, and further permits adjustment of the height or distance between the magnifying lens and the display screen while maintaining a parallel relationship between these two. In this way, the user does not have to alter or modify the electronic device to accommodate the magnifying system, the magnifying system can be removed from the device when it is not being used, and the distance or space between the magnifying lens or element and the display screen can be adjusted to suit the user's need for different magnification and/or bringing the image displayed on the screen into proper focus.

### TECHNICAL FIELD

The present invention relates to magnifying aids for electronic devices, such as hand-held electronic devices having a viewscreen.

### BACKGROUND ART

U.S. Design Pat. No. 383,121 shows the ornamental design of a holder for a screen enhancement system. The system appears to be arranged for easier viewing of a monitor for a personal computer.

U.S. Pat. No. 1,610,252 to R. C. Browne relates to reading glasses and more particularly to devices including a magnifying lens particularly adapted to assist in reading dials, indexes or scales, such as those used on radio sets where exceedingly fine adjustment and reading is desired. The device includes a lens carried in a suitable frame or ring secured at one end by an arm, the opposite end of which is bent at a right angles and embedded in a rubber or resilient suction cup.

U.S. Pat. No. 4,071,174 to Weiner discloses a map holder for automotive vehicles. The map holder features a two-coil coil spring for holding the map between the coils. The spring terminates in a first extremity that is mounted to the dashboard or windshield using a universal joint. The map also terminates in an oppositely mounted second extremity carrying an adjustable mounting for a magnifying glass that is alignable with substantially any part of the area within which the spring turns.

U.S. Pat. No. 4,958,907 to Davis discloses a computer screen magnifier featuring a holder for adjustably positioning a flat sheet magnifier proximate a visual display terminal. The magnifier comprises a mounting for retaining the magnifier and a support for extensibly positioning the mounting in a predetermined, spaced-apart relationship with respect to the terminal.

U.S. Pat. No. 5,847,883 to Rispoli, Jr. discloses an adjustable magnifying apparatus, comprising a generally rectangular-shaped, sheet-like magnifying surface, an adjustable arm having at least one generally hourglass shaped member, with a first end zone having a socket and an opposite, generally parabolic-shaped second end zone.

U.S. Pat. No. 6,417,894 to Goff et al. discloses an optical device and method for adjustably magnifying the visual displays on the screen of a computer monitor or the like.

U.S. Pat. No. 6,634,532 to Maguire discloses a foldable map stand apparatus for automobiles, comprising a means for fastening the apparatus onto an interior surface of the automobile, a pivotally attached telescoping arm for adjusting the angle of display, and a holding means for receiving and displaying a portion of a map.

U.S. Pat. No. 6,795,256 to Wang discloses a hand-held appliance having an optional magnifying function. The appliance has a main body and a display. A connecting element is coupled to the main body at a first end, and to a magnifying device at a second end. In an operational mode, the magnifying device can be switched to be positioned between the display and the user's eyes, thereby magnifying the image on the display to be observed by the user. In one embodiment, the connecting element features a first link and a second link that are pivotally connected to each other, and further pivotally connected to the main body and magnifying device, respectively. In another embodiment, each of the main body and the magnifying device feature a series of through-holes, and the connecting element is an elongated helix strip penetrating through the through-holes to be coupled with the main body and the magnifying device. In another embodiment, the connecting element features a flexible portion physically interfaced between the main body and the magnifying device. In another embodiment, the connecting element includes slits and salient bumps. The slits can be arranged along the sides of the main body, with the salient bumps are fixed onto the inner surface of opposite sides of the magnifying device, or vice-versa. In operation, the salient bumps slide along the slits to place the magnifying device between the display and the user's eyes.

U.S. Pat. No. 6,985,311 to Bartone discloses a cellular telephone flip screen magnifier. The cellular telephone has a base portion and a top portion containing an information screen. The base and top portions are hinged so that the screen is adjacent the base portion in a closed position, but in the open position both the base and screen are exposed to the user. A thin Fresnel magnifying lens is secured to the top portion over the information screen by a pair of cantilevered springs on opposite sides of the screen. The lens is movable between a position adjacent the screen when the top portion is in the closed position, and a normally biased extended position spaced away from the screen to magnify images on the screen when in the open position. The lens may be manually adjustable to permit changes in magnification.

U.S. Pat. No. 7,277,239 to Carnevali discloses a magnification mechanism for viewing an electronic display. The invention provides a magnifier having an optical magnifying lens arranged for optically magnifying an external view that is optically visible through the lens. The invention includes mechanical structure for securing the lens to an electronic device having an optically visible display, with the lens arranged in a magnified focused viewing relationship with the display. According to one aspect of the invention, the magnifying lens is any conventional optical magnifying lens, including optically transparent conventional convex lens and optically transparent Fresnel lens. According to another aspect of the invention, the mechanical structure for securing the magnifying lens to the electronic device is provided by a plurality of flexible clips. The clips may be formed on the surface of the device adjacent to the display, or may be formed on the surface of the magnifying lens. According to another aspect of the invention, the mechanical structure for securing the lens to the electronic device is provided by a cover mechanism having a window aperture formed in a surrounding plate, with the lens arranged in a viewing relationship with respect to the aperture. According to another aspect of the invention, the mechanical structure for securing the lens to the electronic device includes one or more elastomeric pads that are coupled to the side wings and are arranged for gripping opposing side surfaces of the device. In another aspect of the invention, the mechanical structure for securing the magnifying lens to the electronic device includes an offset mechanism that is structured to offset the lens from the electronic device.

The above-mentioned discussion of related art reveals a number of shortcomings and disadvantages. For instance, many of the known devices require one or more modifications to the electronic device to permit the device to accommodate the magnifying apparatus. Some of the above-discussed devices work on only one type of electronic device, for example, those having a hinged, flip-open type of display. Moreover, it may be desirable or even necessary to change the distance between the magnifying lens and the display, for example, to change the amount of magnification, or to adjust the focus. Many of the above-discussed devices have limited capability for this kind of adjustment. More specifically, one way to adjust the distance between the magnifier and the display is to make the connecting element, or a portion of it, flexible. Few of the above-discussed devices feature a flexible element. Of those that do, the flexibility is directed to being able to move the magnifying lens into and out of engagement with the display. It does not permit adjustment of the distance between the lens and the display when the lens was “in position” for viewing a magnified image through the lens.

Various embodiments of the instant invention address these deficiencies.

### DISCLOSURE OF THE INVENTION

According to the instant invention, to assist a human user in seeing a display of information such as on a display screen of a piece of electronic equipment, a simple magnifying apparatus is removably or temporarily attached near the display screen. The display screen can be that of an electronic device such as a portable electronic device, particularly a hand-held electronic device such as a cellular telephone, a personal digital assistant (PDA), hand-held computer, a personal navigation system, portable music device and the like. The apparatus features an element that connects a magnifying element to an element that removably attaches to the electronic device, where the device optionally permits the magnifying element to be moved into and out of position over the display screen, and further optionally permits adjustment of the height or distance between the magnifying element and the display screen while maintaining a parallel relationship between these two. In this way, the user does not have to alter or modify the electronic device to accommodate the magnifying system, the magnifying system can be removed from the device when it is not being used, and the distance or space between the magnifying lens or element and the display screen can be adjusted to suit the user's need for different magnification and/or bringing the image displayed on the screen into proper focus.

### BRIEF DESCRIPTION OF THE FIGURES

FIGS. 1A through 1D are isometric front and rear views of an embodiment of the invention featuring a “skin” with a stem and a removable stabilizer pin.

FIGS. 2A through 2D are isometric front and rear views of an embodiment of the invention featuring a “skin” with a stem having “stabilizer bends”.

FIG. 3 is an isometric view of a stem having a stabilizer bend.

FIGS. 4A through 4C are isometric rear views of an embodiment of the invention featuring a skin having storage pockets for the magnifier and stem.

FIGS. 5A through 5E are side views of an embodiment of the invention where the attachment means features a suction cup.

FIGS. 6A-6B and 6D-6E are side views of an embodiment of the invention where the attachment means features a magnet; FIG. 6C is a rear view.

FIGS. 7A-7B and 7D-7E are side views of an embodiment of the invention where the attachment means features a hook-and-loop attachment system; FIG. 7C is an isometric view.

FIGS. 8A through 8D illustrate an embodiment of the invention in which a skin features a “spine” for gripping the stem.

FIGS. 9A through 9D show various aspects of a rubber grommet as used in the instant invention.

FIG. 10 is a front view of a magnifier sheet containing a hole arranged to receive a rubber grommet.

FIG. 11 is a side view of a suction cup (left) placed against a smooth surface, and a side view of a suction cup (right) pressed firmly against a smooth surface;

FIGS. 12A and 12B are rear views showing two different means for attaching the stem to the suction cup.

FIG. 13 shows a stem and stabilizer pin.

FIG. 14 is a front view of a magnifier sheet.

FIGS. 15A through 15D are perspective views of a housing that fits over at least the viewscreen portion of an electronic device.

### LISTING OF REFERENCE SIGNS AND FEATURES DENOTED BY THEM

10 suction cup

12 groove

14 flange

30 electronic device

31 top edge of electronic device

32 display screen

34 keypad

36 housing

38 top edge of housing

41 horizontal component

42 connector element

43 vertical component (of connector element)

44 suction cup

45, 45′ jaws

46 clamp

47, 47′ wings

48 pivot mechanism

52 retaining clip

62 plastically deformable connector element

64 clamp

72 soft metal

74 pliable, flexible plastic

82 skin

84 spine

90—magnifying element

92—flexible stem

94—rigid stem

96—magnet

98—stem

102—stem sleeve with “hook-and-loop” backing for stem with stabilizer pin

104—rigid stem with stabilizer pin hole

106—stabilizer pin

108—hook-and-loop adhesive strip

110—rigid stem with stabilizer bends

111—stabilizer bends

112—magnifying element with single hole for grommet

115—groove in grommet

116—rubber grommet

117—center hole in grommet

118—hole in magnifier

119—hole in magnet

120—stem

121—hole in stem

122—skin with sleeve for stem with stabilizer pin

123—display screen and/or keypad window

124—sleeve for stem with stabilizer pin

126—skin with tailored sleeve for stem with stabilizer bends

127—skin with storage pockets

128—tailored sleeve

130—elastic cord

132—soft lined storage pocket for magnifier lens

134—storage pocket for stem

136—stem sleeve tailored for stem with stabilizer bends with hook-and-loop backing

146—storage slot for stem

150—stem sleeve tailored for stem with stabilizer bends

152—partial skin

156—stem with stabilizer bends

158—stem with stabilizer bends

### MODES FOR CARRYING OUT THE INVENTION

One or more embodiments of the invention provide an apparatus whereby a magnifying element can be temporarily placed in the vision path of a user and an electronic device having a display or view screen. By “temporary” what is meant that the user can move the magnifying element out of the visual path when he or she is done viewing a magnified version of the image displayed. One or more embodiments of the invention features the magnifying element being adjustable in terms of its height relative to the display or view screen. All embodiments of the invention feature a device that is removably attachable to the electronic device, that is, not permanently attached to the electronic device. In one or more embodiments, however, the apparatus may be permanently attached to a housing or “skin” which itself may be removably attached to the electronic device.

Types of Attachment

Various embodiments of the invention contemplate a number of scenarios for removably, that is, “temporarily” attaching the apparatus to the electronic device. In one such embodiment, the apparatus is temporarily attached to the electronic device by means of a suction cup.

In another embodiment, the temporary attachment may be made by means of a hook-and-loop attachment system such as VELCRO®. More particularly, this type of attachment system features a pair of fabrics or similar flexible material. One of the fabrics of flexible material features a surface containing a large number of tiny, closely space loops. The other of the pair of fabrics features a surface containing a very large number of tiny hooks. The loops and hooks typically are made from a stiff rigid plastic. When the surfaces are brought together, the hooks engage the loops, thereby locking the two surfaces together until a much larger force comes along to pull the hooks out of the loops.

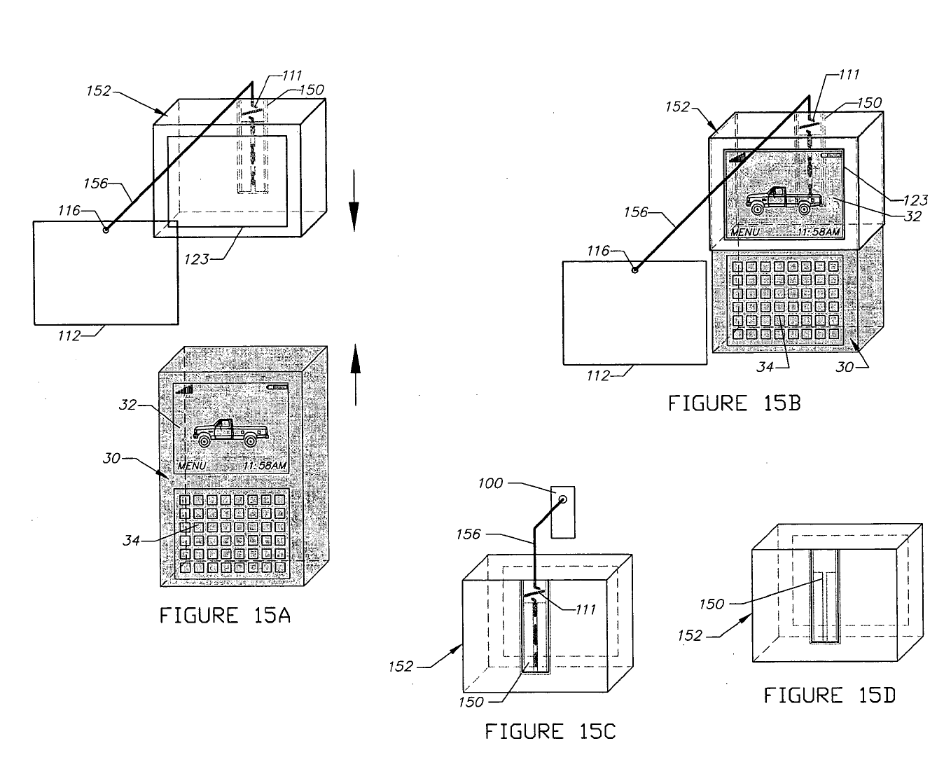

In yet another embodiment, the apparatus may be permanently or temporarily attached to a structure that is arranged to attach to the electronic device by at least partially covering the device. In other words, the structure functions as a housing, cover or “skin” for the electronic device. The term “skin” here also includes the meaning given in the trade; that is, a covering typically sold as an accessory for the electronic device, and which is often used to customize the outward appearance of the electronic device. Such skins traditionally have been decorative, in other words. One example of such a partial housing is shown in Figure 15. Here, the housing 152 is arranged to slide over electronic device 30 (or electronic device 30 is arranged to slide into housing 152). When the top edge of the housing contacts the top edge of the electronic device, the engagement is complete.

In a further embodiment, the temporary attachment may be by means of an adhesive such as contact cement, elastomeric materials such as rubber bands or belts, or mechanical fasteners that do not require making holes in the electronic device, such as metal clips or other metal parts that rely on the elasticity of the metal for the gripping effect. Other existing temporary attachment means should be obvious to those skilled in the art.

In yet still another embodiment, a combination of two or more of the above- discussed attachment mechanism may be employed. For example, the apparatus may be used in conjunction with a housing or skin, but the apparatus may be attached to such housing or skin by means of a suction cup or by means of a hook-and-loop fastener system. Thus, the instant invention adds functionality to the housing or skin.

Types of Magnifiers

The present apparatus is intended to work with most any magnifier that can provide optical magnification of an image on a viewscreen of a reasonable degree when the user is positioned at roughly normal viewing distance from the viewscreen and the magnifier is placed no more than about eight inches above the surface of the viewscreen. In the first instance, it may be desirable to magnify only the viewscreen and not, for example, other portions of the electronic device, such as the keyboard. Optionally, however, it might not be distracting to the user if the keys of the keyboard are magnified, but the user may feel more comfortable if the entire keyboard is subject to optical magnification and not just a portion.

Magnifiers such as convex lenses (commonly fashioned from glass or plastic) and Fresnel lenses will come to mind as being suitable for the present application. Fresnel lenses in particular are thin, lightweight and low cost. They can be easily secured with a clamp, such as one similar to those used in the office environment to clamp sheets of paper together. In this way, the Fresnel lenses are readily interchangeable, and in fact, the present invention contemplates that the user may wish to have several Fresnel lenses at his disposal, for example, lenses of different physical size and/or different magnifying power. Since most Fresnel lenses are readily cut with ordinary household tools such as scissors or knives, it should be possible to supply the user with one or more large sheets of Fresnel lens material and permit the user to cut his or her own lens of desired size and shape. A frontal view of a magnifying element is depicted as item 90 in FIG. 14. Other existing magnifying elements that may be used in connection with the present invention should be obvious to those skilled in the art.

The Connector Element

The present apparatus features a structural element that connects the attachment means to the magnifier. This element furthermore provides structural support to the magnifier when the apparatus is in use. It supports the magnifying element in a substantially stationary position when in use, at a substantially fixed angle with respect to the plane of the viewscreen (and generally parallel), and at a substantially fixed height with respect to the viewscreen. At the same time, the connector element permits the user to quickly and easily move the magnifying element into and out of position over the viewscreen. It also permits the user to adjust the elevation or height of the magnifying element above the viewscreen as desired by the user. It also permits the user to adjust the angle between the magnifying element and the viewscreen, at least to some extent. This is necessary because the viewscreens on some electronic device may be inclined somewhat with respect to the base or chassis of the electronic device, and an apparatus without means for adjusting this angle might not enable the user to bring the magnifying element into parallel alignment with the viewscreen. A number of embodiments are contemplated in the present invention, including an elongated embodiment referred to as a “stem”.

Again, the stem functions to hold the magnifying lens or “element” in position between the user's eyes, and the portion of the device the user wishes to view. To increase the efficiency of the frictional interaction with a grommet, stems may developed with either a smooth circular cross section, (the straight portions of stem resembling a rod), or something other than circular, such as a hexagonal cross-section (the straight portions of stem resembling a hexagon). Depending on manufacturing options, other cross sectional shapes may be explored, for instance polygons such as (but not limited to) pentagonal, heptagonal, or octagonal cross sections.

How to Use an Embodiment of the Invention

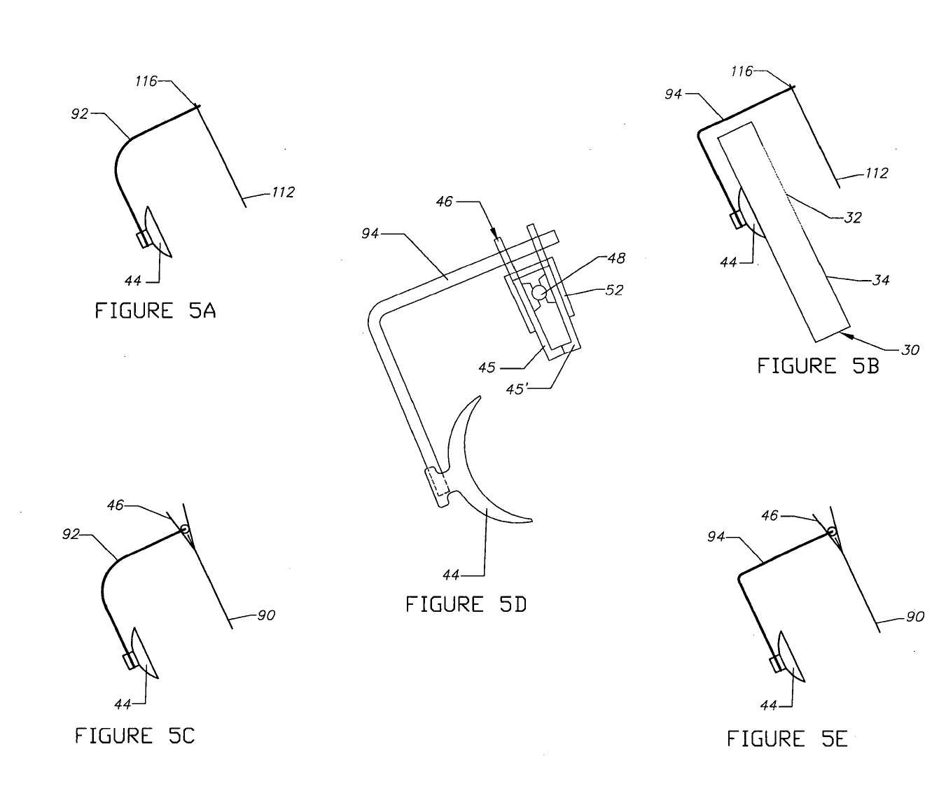

Using FIGS. 5B and 5D as an example, the apparatus is attached to the portable electronic device, if it is not already so attached. In particular, the user positions the suction cup against a smooth, flat portion of the back face or surface of the electronic device in such a way that the connector element is front-and-center. The user then presses the suction cup firmly against this surface, which deforms the soft, pliable plastic making up the suction cup, and expelling most of the air situated between the suction cup and the surface of the electronic device. The user then releases the pressure, and the suction cup remains adhered to the surface.

The user then opens the jaws of the clamp by squeezing the ears or wings of the clamp toward one another. The user places a Fresnel lens into the open jaws, and then releases the pressure or force on the ears or wings. The biasing spring of the clamp causes the jaws to close against each other, thereby firmly gripping the Fresnel lens. The user then rotates the clamp about the connecting element until the Fresnel lens is substantially opposing and aligned with the viewscreen of the electronic device. If necessary, the user can rotate the connector element about the suction cup to help bring the Fresnel lens into the desired alignment. The user then looks at the viewscreen through the Fresnel lens, preferably at an angle that is close to perpendicular to the plane of the viewscreen. The user adjust the height or elevation of the Fresnel lens above the viewscreen until the image displayed on the viewscreen comes into the proper focus and provides the user with an appropriate magnification.

How to Use Another Embodiment of the Invention

This embodiment is similar to the one described immediately above, except that it includes a housing or skin for the electronic device.

Here, the apparatus is attached to the back side or surface of the housing or skin. The attachment may be by suction cup, hook-and-loop, snap or other type of temporary fastener. Alternatively, the attachment to the housing or skin may be permanent. Then, the housing or skin is attached to the electronic device. In one version, this attachment takes the form of the electronic device being slid into the housing to the desired extent. The housing is so shaped as to not obscure the viewscreen or the keys of the keypad or keyboard.

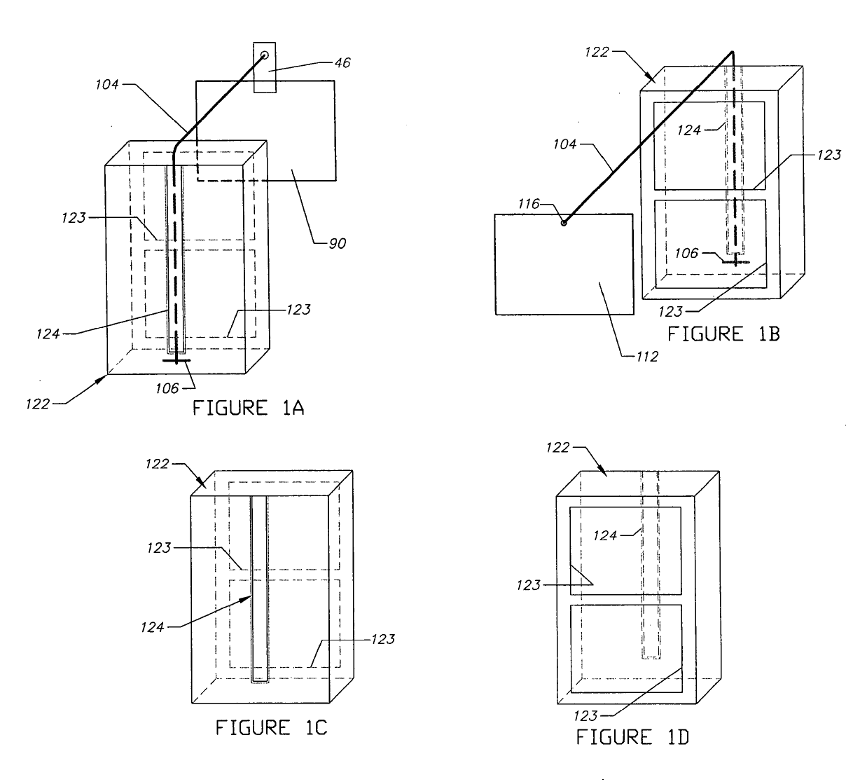

If not already in existence, housings or “skins” can be developed with various dimensions to fit different models of devices. The embodiments may be constructed from some or all of (but not limited to) the following materials (natural or synthetic): fabric, batting, stitching, string or cord, elastic cord, strapping, buttons, zippers, VELCRO®, neoprene, leather, soft plastic, rigid plastic and/or rubber. These embodiments may also be manufactured to provide other small openings or holes (which have not been depicted in the drawings) to allow the user to access certain features of the device without removing the skin. For example, a hole may be provided to allow the user to plug in a power cable or headset without removing the skin. Other holes or openings may be provided to allow the user to access volume controls or other buttons on the device which otherwise would become covered and inaccessible under the skin. These options would be manufactured differently for various models of devices. In order to provide visual and tangible access to the device, skin embodiments may feature separate windows 123 to access the device's 30 keypad 34 and display screen 32 as depicted in FIG. 1D, or may be manufactured with a single large widow 123 for the same purpose. Depending on the skin's dimensions and materials, windows may or may not be intended for the additional function of providing a means of inserting or removing the device from the skin. Skin embodiments may be manufactured with different display screen window and keypad window configurations to provide a good fit on different model devices. Windows may or may not be outfitted with a clear plastic which will protect the device from scratches while allowing the user to view the screen. All skins should provide a means by which the user can insert and remove the device from the skin. This may be accomplished by providing an open top through which the device could pass at any time the stem was not in place. This option would provide a quick way for the user to insert and remove the device from the skin. Alternatively, one of the top, bottom, or side portions of the skin could be attached to the skin on one side only, creating a door or “flap” which could be opened, providing an opening large enough for the device to pass thru . VELCRO®, zippers, fabric, cords or buttons (or other means) could be used to secure the flap once the device has been inserted into the skin; this would ensure the device does not come out of the skin.

### EMBODIMENT 1

### Skin with Stem and Removable Stabilizer Pin

This embodiment represents a skin 122 with a sleeve 124 on the back that accepts and holds a stem 104 with a stabilizer pin 106 as depicted in FIGS. 1A, 1B, 1C and ID. The stem 104 and stabilizer pin 106 are also shown in greater detail in FIG. 13. The sleeve 124 allows the stem 104 to extend through the bottom of the sleeve 124, such that a hole 121 in the stem 104 is exposed allowing the user to insert a stabilizer pin 106. This pin 106 prevents the stem 104 from unwanted rotation during use, and can be easily removed when the stem needs to be removed from the skin for storage. The hole 121 in stem 104 for stabilizer pin 106 may be outfitted with a rubber grommet to provide increased frictional efficiency between the stem 104 and the stabilizer pin 106, allowing the pin 106 to be inserted easily, while still providing enough friction to prevent the pin from coming out. This embodiment may be developed utilizing different means of attaching the magnifier element to a stem; for example, a clamp means which will be described later in connection with FIG. 5D, or a rubber grommet means may be used.

### EMBODIMENT 2

### Rubber Grommet

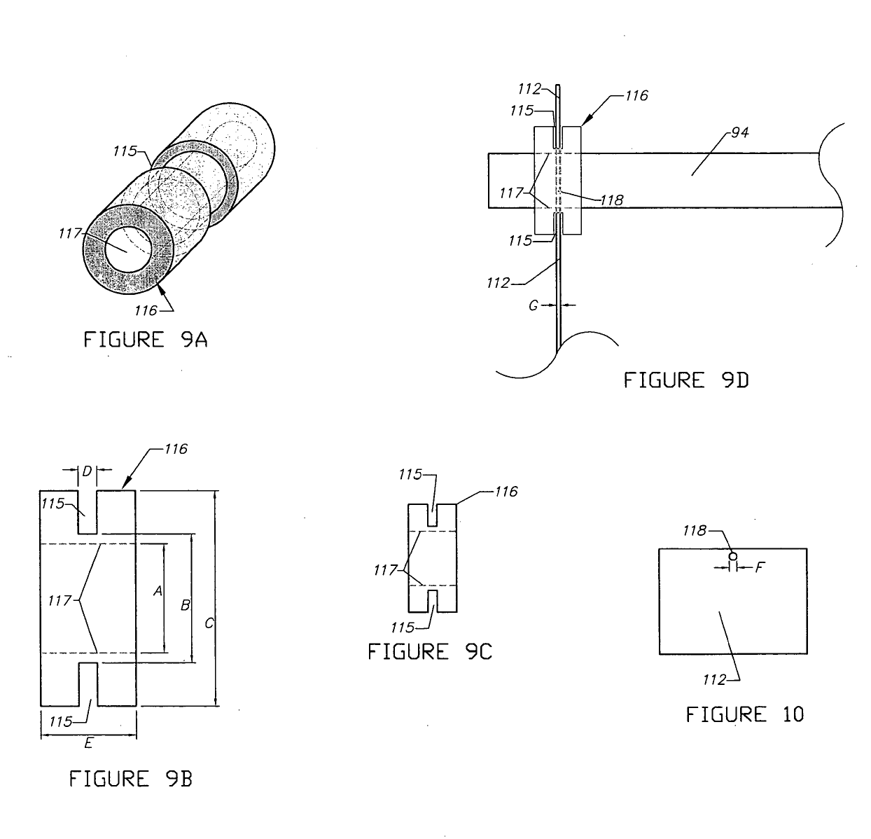

A rubber grommet 116 may be used to attach the magnifier112 to the stem 94. With specific regard to grommet 116, its construction is from a soft, rubber or plastic (such as, but not limited to, silicone, Buna-N, Viton®, Neoprene, or EPDM) as typically (but not exclusively) manufactured by WESTERN RUBBER and SUPPLY INC., 7888 Marathon Drive, Suite F, Livermore, Calif., 94550, USA. Elastic deformation of the grommet 116 allows for the grommet to be pushed into a premade hole 118 in the magnifier lens 112 without damaging the grommet or the magnifier lens. The grommet 116 is constructed such that the outside diameter of the grommet 116 (FIG. 9B, dimension C) is larger than the diameter of the hole 118 in the magnifier lens (FIG. 10, dimension F). The outside diameter of inner ring of the grommet 116 (FIG. 9B, dimension B) preferably is approximately the same size as the hole 118 in the magnifier lens 112 (FIG. 10, dimension F). The width of the groove 115 in the grommet 116 (FIG. 9B, dimension D) preferably matches (or is slightly smaller than) the thickness of the magnifier lens 112 (FIG. 9D dimension G) to provide friction between the grommet 116 and the magnifier lens 112. Once inserted, the grommet 116 is held in place because the outer rings of the grommet 116 are larger than the hole 118 in the magnifier. The grommet 116 features a hole 117 in the center extending through the full length of the grommet. Referring now to the dimensions and details of the grommet illustrated in FIGS. 9A through 9D, the inside diameter of this hole 117 (FIG. 9B, dimension A) preferably is the same diameter (or very slightly smaller) as the outside diameter of the stem 94. Once the grommet 116 has been installed in the hole 118 in the magnifier 112 (see FIG. 10), the stem 94 can be pushed into and through the center hole 117 of the grommet 116 and the force of friction between the grommet 116 and the stem 94 will hold the magnifier/grommet assembly in place on the stem 94. The diameter of the center hole 117 (FIG. 9B, dimension A) in the grommet 116 is constructed to provide enough friction to hold the magnifier/grommet assembly in place on the stem 94 during use, but preferably not provide too much friction to prevent the easy assembly, adjustment, and disassembly by the user. The magnifier/grommet assembly preferably has the ability to be slid up and down the length of the stem, allowing the user to position the magnifier at the proper distance from the display screen of the device, bringing the image into focus. FIG. 9C depicts a side view of the grommet alone. FIG. 9D depicts the magnifier, grommet, and stem in their assembled positions.

### EMBODIMENT 3

### Skin with Sleeve for Stem with Stabilizer Bends

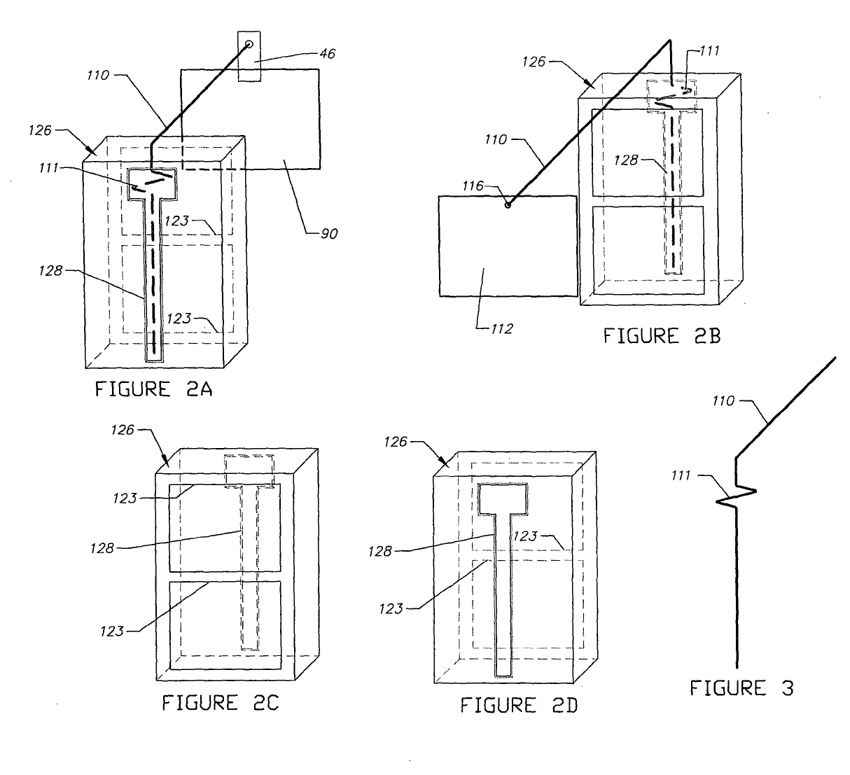

Referring to FIGS. 2A-2D and 3, this embodiment represents a skin 126 with a sleeve 128 on the back that accepts and holds a stem 110 with stabilizer bends 111. The sleeve 128 holds the full length of the stem 110 and the stabilizer bends 111. The sleeve 128 is tailored such the lower portion of the sleeve will be narrower than the top portion, such that the straight portion of the stem and the bent portion 111 are both held snugly. The restriction of the bends 111 by the sleeve 128 prevents the stem 110 from unwanted rotation during use, e.g., rotation out of or away from the plane defined by the bends. This embodiment may be developed utilizing different means of attaching the magnifier element to a stem; either a clamp method as depicted in FIG. 5D, or rubber grommet method as depicted in FIG. 9D may be used.

### EMBODIMENT 4

### Skin with Storage Pockets for Magnifier and Stem

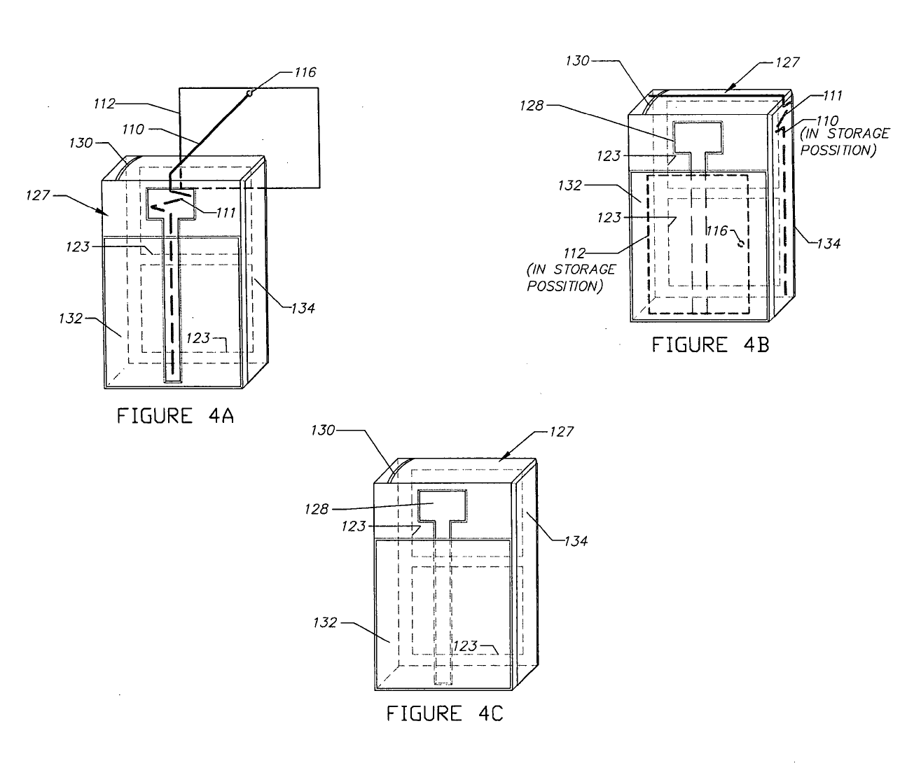

Referring now to FIGS. 4A through 4C, this embodiment represents a skin 127 similar to skin 126, with the addition of storage pockets 132 and 134 to hold the magnifier 112 and the stem 110 when not in use. Alternatively, or in addition, a piece of elastic material such as an elastic cord 130 may be used. The stem 110 with stabilizer bends 111 and associated tailored sleeve 128 can be the same as described for Embodiment 2 and depicted in FIGS. 2A, 2D and 3. This embodiment may be developed utilizing different means of attaching the magnifier element to a stem, such as a clamp means as depicted in FIG. 5D, or rubber grommet means as depicted in FIG. 9D.

### EMBODIMENT 5

### Skin with Spine

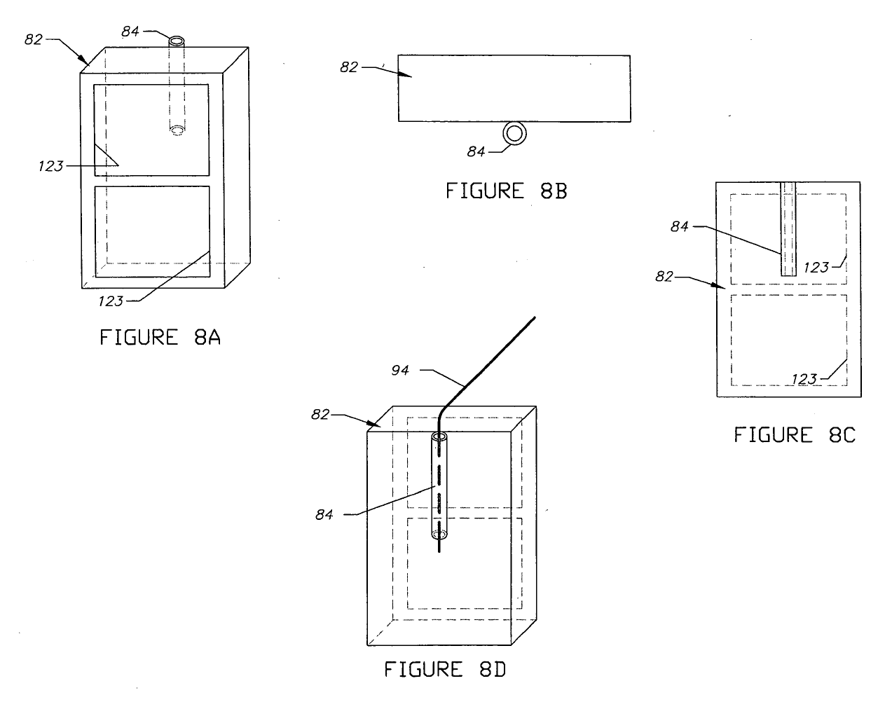

Another technique for temporarily or permanently attaching the apparatus to the housing or skin is illustrated in FIGS. 8A through 8D. What is shown specifically in FIGS. 8A through 8D are isometric front, orthogonal top, orthogonal rear and isometric rear views of a skin 82 large enough to accept essentially the entire electronic device; that is, the user can slide the entire electronic device into this cover. The skin or cover features a tube or “spine” 84 attached to the back surface of skin 84, for example, by means of adhesive, stitching, etc. The axis of the spine is essentially parallel to the plane of the back surface. The spine may be sized slightly smaller than the cross-section size of the connector element but at least slightly elastic and having at least some degree of friction with respect to the connector element. In this way, rather than attaching a suction cup to one end of the connector element, that end is inserted at least partway into the spine, with the result that the spine sufficiently grips the connector element that it prevents the apparatus from falling out of the spine or rotating away from the desired orientation with respect to the electronic device.

### EMBODIMENT 6

### Suction Cup and Stem

This embodiment represents the utilization of a suction cup to temporarily mount the stem (rigid or flexible) directly to the body of the hand held device. The use of a suction cup allows the user to quickly attach and detach the assembly to and from the device.

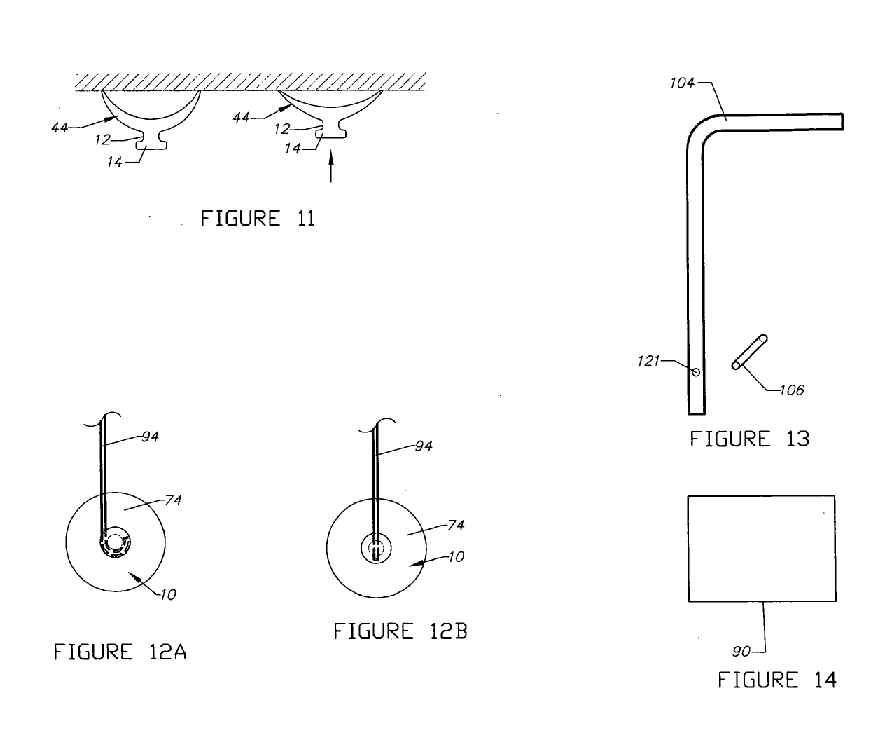

A cross-section of a suction cup 44 is shown in FIG. 11. A suction cup typically is produced from a very soft, flexible plastic such as an elastomer. The idea is that when a suction cup is pressed against a flat, smooth but unyielding surface, the flexible plastic deforms, permitting the air between the suction cup and the surface to which it is to be adhered to be expelled. When pressure on the suction cup is released, however, air cannot re- enter the zone between the cup and the surface to which it was pressed. The result is that the suction cup remains adhered to the smooth flat rigid surface. But the purpose or function of a suction cup is usually not to bond the cup per se, but instead to bind other structures to the smooth flat surface. To this end, suction cups typically feature means for attaching the cup to other structures. In FIG. 11, what is shown is a suction cup having a recess or groove 12 and a lip or flange 14. These latter two cooperate to permit other structures such as a rod or wire stock to be wound partially or completely around the recessed area, thereby joining the rod or wire stock to the suction cup. Referring to FIGS. 12A and 12B, the stem (rigid or flexible) may be attached to the suction cup by inserting the stem into a hole in the solid portion of the suction cup (FIG. 12B). The assembly may be secured with glue if necessary. Alternatively, the stem may be permanently bent around the end of the suction cup (FIG. 12A).

### EMBODIMENT 7

### Rigid Stem

In one embodiment of the present invention, the connector element or stem is substantially fixed or rigid. One embodiment features fixed beams or rods (e.g., cantilevered beams). Referring to FIG. 5D in particular, in this embodiment the connector element 94 features a lower portion and an upper portion. The lower and upper portions are fabricated from substantially rigid materials such as aluminum alloy or rigid plastic such as polystyrene. The lower end of the connector element is joined to the attachment means, here a suction cup 44. The suction cup features a lip or flange with a recess. The beam is joined to the suction cup by wrapping its end at least partially around the recessed area of the suction cup. Optionally, the connector element is free to rotate about the suction cup; that is, it may rotate in a plane substantially parallel to the plane of the surface to which the suction cup is attached.

The other end of the connector element (e.g., the upper end) has mounted on it a means for holding the magnifying element. Here, that means is a clamp 46. The clamp features two jaws 45, 45′, the jaws normally being closed against one another. At the opposite end of the clamp are “wings” 47, 47′, and in between the jaws and the wings is a pivot mechanism 48. The user may open the jaws of the clamp by squeezing the wings toward one another. The clamp features a spring or spring mechanism that holds or biases the jaws such that they are normally in the closed position and that they may be opened only by exerting pressure on the wings, specifically by squeezing them toward one another. Here, the biasing spring takes the form of a retaining clip 52 having a “C” cross section (see FIG. 5). The clamp also features a hole extending through each of the upper and lower wings. The holes are circular and sized to accommodate the vertical portion of the connector element, which also has a circular cross-section. When the wings are squeezed toward each other, the holes come into perfect alignment, and the user is able to slide or otherwise move the clamp up or down along the vertical component of the connector element. When the pressure is released and the wings are pushed back to their normal position by the spring, the holes are slightly out of alignment. The friction between the vertical component of the connector element and the clamp material adjacent the holes causes the clamp to remain in position along the vertical component. Furthermore, there is also rotational friction between the vertical component and the clamp material. That is, when the user attempts to rotate the clamp around the axis of the vertical component, this is do-able, but the vertical component puts up a slight resistance. This permits the user to rotate the viewing screen into and out of position over the viewscreen, and the magnifier will stay in the new position due to this friction.

Last but not least, the clamp permits the user to change the magnifying element to one of a different magnifying power or size or shape. It also permits the apparatus to be disassembled into a more compact size for portability. FIG. 5E shows the rigid stem and clamp embodiment in use with a magnifying element. FIG. 5B shows the rigid stem embodiment used with the rubber grommet embodiment to hold the magnifying element 112. The electronic device 30 is also shown.

### EMBODIMENT 8

### Flexible Stem

Another embodiment of the connector element is based on this element being flexible, malleable or plastically deformable. Unlike the previous embodiment, here the connector element is not rigid, or at least not completely rigid. At the same time, it should not be completely elastic; that is, it should not exhibit complete shape memory. Instead, what is desired is being able to change the orientation of the connector element, for example, by bending or twisting, and to have the connector element assume or retain the new shape or orientation. Examples of products that possess this property include “gooseneck” microphones and shielding for electrical wire, sometimes referred to as “armored wire”. Examples of materials that possess this property include modeling clay and many metals. Not all metals are suitable in this embodiment. Metal provided as a single rod or wire, or otherwise in monolithic form, has to be capable of being deformed numerous times without failing due to metal fatigue. Fortunately, a number of metals, particularly those with little or no alloying, meet this condition. In this embodiment, the user can move the magnifying element into and out of position, and make all of his adjustments (height, lateral and angular alignment, etc.) simply by deforming the connector element, or a deformable portion thereof. Thus, it is not required that the lower portion of the connector element rotate around the suction cup 44, nor is it required that the clamp 46 be able to move along the connector element, or even that it be able to rotate about the connector element axis. In this embodiment, the connector element may not have an axis as such.

This plastically deformable connector element may be a single monolithic material such as a soft metal wire or rod, or it may be a combination of materials such as soft metal covered or protected by soft, pliable, flexible plastic.

The flexible stem embodiment is shown as number 92 in FIGS. 5A and 5C. FIG. 5A features the rubber grommet embodiment for holding the magnifying element 112; FIG. 5C features a clamp 46 for holding magnifying element 90.

### EMBODIMENT 9

### Magnet and Stem

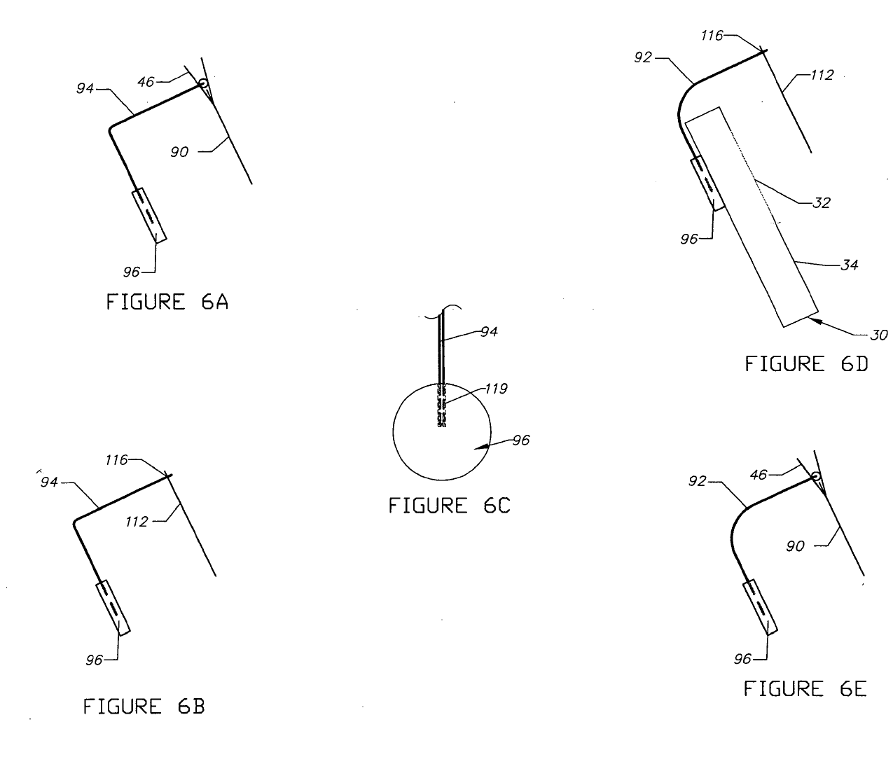

Referring to FIGS. 6A through 6E, this embodiment represents the utilization of a magnet 96 to hold the stem 94 directly to the body of the hand held device 30. The stem 94 will hold the magnifying lens 112 in position between the user's eyes and the display screen 32 of the device 30. The use of a magnet will allow the user to quickly attach and detach the assembly to and from the device 30. Referring specifically to FIG. 6C, the stem 94 will be attached to the magnet 96 either by inserting the stem 94 into a hole 119 in magnet 96 (the assembly may be secured with glue if necessary). Alternatively, the stem 94 could be inserted and glued into a hole 119 drilled in the magnet 96, and then the entire magnet 96 could be encased in rubber or plastic, sealing the stem 94 and magnet 96 together, while also serving to protecting the device 30 from direct contact with the magnet 96, helping to prevent scratching of the device 30 by the magnet 96. The stem may be either flexible 92 or rigid 94 as described. This embodiment may be developed utilizing different means of attaching the magnifier element to a stem; either a clamp method as depicted in FIG. 5D, or rubber grommet method as depicted in FIG. 9D may be used. FIGS. 6A and 6E show the rigid and flexible stem embodiments, respectively, in combination with the clamp means for holding the magnifying element 90. FIGS. 6B and 6D show the rigid and flexible stem embodiments, respectively, in combination with the rubber grommet means for holding the magnifying element 112. The electronic device 30 is also shown in FIG. 6D.

### EMBODIMENT 10

### Velcro® Sleeve and Stem

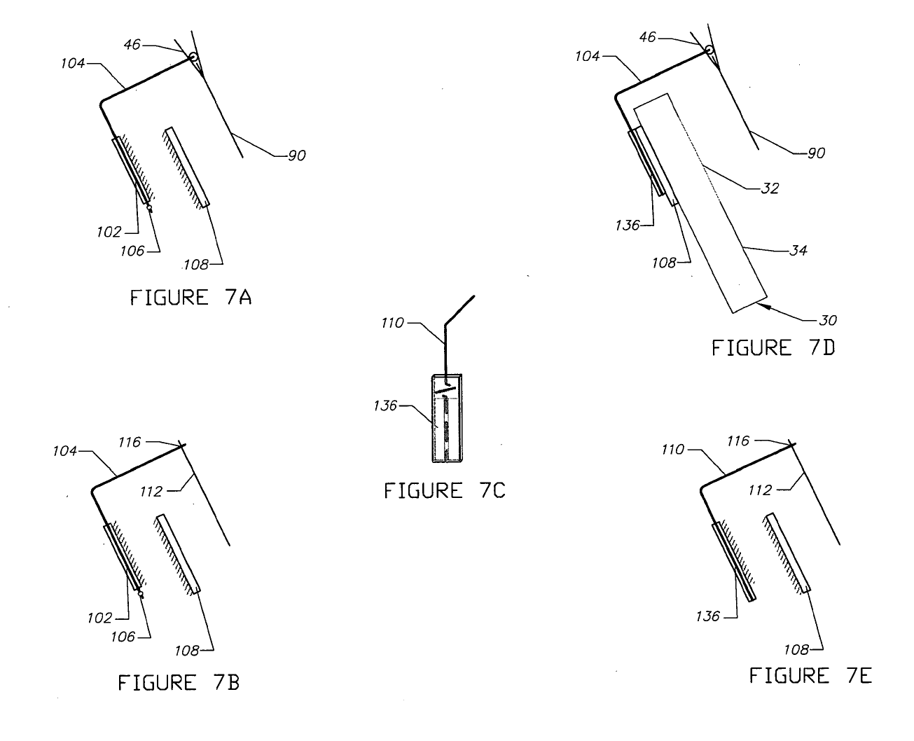

This embodiment provides the user with a way to remove the sleeve and stem from the device. Referring now to FIGS. 7C and 7D, this embodiment represents the utilization of a sleeve 136 constructed of fabric, stitching, and VELCRO® (hook and loop) to hold the stem 110 (having stabilizer bends) in such a manner that it will hold the magnifying lens 90 in position between the user's eyes and the display screen 32 of the device 30. A piece of VELCRO® 108 with an adhesive backing is provided which the user semi- permanently attaches to the handheld device 30. A corresponding piece of VELCRO® makes up (or is sewn to) the back of the sleeve 136 which holds the stem 110. The sleeve 136 may be tailored to provide a long slender pocket for the straight portion of the stem 110, and a wider portion near the top which holds the stem's stabilizer bends 111 tightly. This should prevent rotation of the stem 110 during use. Once the adhesive VELCRO® strip 108 has been applied to the back of the device 30, the sleeve 136 with VELCRO® backing can be affixed to the VELCRO® strip 108 on the back of the device 30. The stem 110 can then be inserted into the sleeve 136 and the magnifier 112 can be positioned on the stem 110. This embodiment may be developed utilizing different means of attaching the magnifier element to a stem; either a clamp method as depicted in FIG. 5D, or rubber grommet method as depicted in FIG. 9D may be used. FIG. 7A shows the rigid stem embodiment in combination with the clamp means for holding the magnifying element 90. FIG. 7D is substantially similar to FIG. 7A, but also shows electronic device 30 in position. FIGS. 7B and 7E show the rigid stem embodiments, without and with the stabilizer bends, respectively, in combination with the rubber grommet means for holding the magnifying element 112.

Another option for the sleeve and stem configuration is depicted in FIG. 7A utilizing a stem 104 with stabilizer pin 106. The sleeve 102 shall allow the stem 104 to extend through the bottom of the sleeve 102, such that a hole 121 in the stem is exposed allowing the user to insert a stabilizer pin 106. This pin 106 will prevent the stem 104 from unwanted rotation during use, and can be easily removed when the stem 104 needs to be removed from the sleeve 102 for storage. In either option, the sleeve will be constructed either by using the VELCRO® as the main fabric for the side which will be facing the back of the device, or VELCRO® the will be sewn to the fabric making up the sleeve. A thin piece of plastic may also be used in the construction of the sleeve to provide a more rigid assembly.

### EMBODIMENT 11

### Partial Skin

This embodiment represents a partial skin 152 which only covers a portion of a device 30 for the purpose of providing the physical support for a stem 156 which will hold a magnifier 112 in position in front of the device during use. FIG. 15A depicts the partial skin 152 and electronic device 30. The arrows in FIG. 15A represent the direction of motion required to slide the electronic device 30 into the skin 152. The skin 152 shall be constructed with an open bottom, allowing the electronic device 30 to be pushed into the skin 152 without obstruction. FIG. 15B depicts the embodiment with electronic device 30 slid into the skin 152. The skin's window 123 allows visual access to the electronic device's display screen 32 while providing the physical support for the stem 156 and magnifier 112. As illustrated in FIGS. 15C and 15D, a tailored sleeve 150 on the back of the skin 152 accepts and holds the stem 156. The sleeve 150 shall function in the same way as sleeve 128, (described above). Although it is not illustrated, other means of stem stabilization may be used, such as the stabilizer pin 106, as depicted in FIGS. 1A, 1B, and 13, or the spine (84) as shown in FIGS. 8A, 8B, 8C, 8D.

This embodiment may be developed utilizing different means of attaching the magnifier element to a stem; either a clamp method as depicted in FIG. 5D, or rubber grommet method as depicted in FIG. 9D may be used.

### INDUSTRIAL APPLICABILITY

The methods and compositions of the present invention should find utility in helping to read the visual display of information presented by an electronic device, particularly a hand-held electronic device such as a cellular telephone, a personal digital assistant (PDA), hand-held computer, a personal navigation system, portable music device and the like. Moreover, the instant invention should also find utility in magnifying the display screens or other forms of output of other devices that may not necessarily be portable or personal, such as displays in the interior of an automobile such as the displays, dials or gauges on the instrument panel, a built-in car navigation device or a map holder. The device of the instant invention can also be attached to larger, perhaps stationary machines or instruments to assist in viewing their information output devices such as dials, gauges, digital readouts, etc.

An artisan of ordinary skill will appreciate that various modifications may be made to the invention herein described without departing from the scope of the invention as defined in the appended claims.

What is claimed is:

1. A detachable magnifier apparatus to assist a human user in seeing a display of information, comprising:
(a) means for releasably attaching said apparatus near said display in such a way that said user can position an optical magnifier into a visual path between said display and at least one eye of said user; and
(b) a connector element connecting said optical magnifier to said attachment means.

2. The apparatus of claim 1, wherein said display is produced by a portable electronic device, and said attaching means is attached to said portable electronic device.

3. The apparatus of claim 1, further comprising said optical magnifier.

4. The apparatus of claim 1, wherein said connector element is flexible.

5. The apparatus of claim 1, wherein said connector element is substantially rigid.

6. The apparatus of claim 1, wherein said connector element comprises a malleable metal.

7. The apparatus of claim 1, wherein said connector element comprises a stem.

8. The apparatus of claim 7, wherein said stem comprises a wire or rod.

9. The apparatus of claim 7, wherein said stem has a smooth circular cross-section.

10. The apparatus of claim 7, wherein said stem has cross-section that is other than circular.

11. The apparatus of claim 7, further comprising a stabilizer member attached to said stem, said stem having at least one substantially straight segment that defines an axis, and wherein said stabilizer member is arranged to limit rotation about said axis.

12. The apparatus of claim 7, wherein said stabilizer member comprises at least one bend in said stem.

13. The apparatus of claim 11, further comprising a pocket or sleeve arranged to receive said stem and said stabilizer member.

14. The apparatus of claim 1, wherein said connector element comprises a structural material covered with a protective material.

15. The apparatus of claim 14, wherein said protective material comprises plastic.

16. The apparatus of claim 1, further comprising a means for releasably attaching said optical magnifier to said connector element.

17. The apparatus of claim 16, wherein said means for releasably attaching said optical magnifier to said connector element comprises a grommet.

18. The apparatus of claim 17, wherein said grommet engages a hole in said magnifying element.

19. The apparatus of claim 16, wherein said means for releasably attaching said optical magnifier to said connector element comprises a spring-biased clamp.

20. The apparatus of claim 19, wherein said spring-biased clamp is free to rotate about said connector element.

21. The apparatus of claim 19, wherein said spring-biased clamp is free to translate along at least a portion of said connector element.

22. The apparatus of claim 1, wherein said means for releasably attaching said apparatus to said portable electronic device comprises a suction cup.

23. The apparatus of claim 1, wherein said means for releasably attaching said apparatus to said portable electronic device comprises a hook-and-loop fastener system.

24. The apparatus of claim 23, wherein one part of said hook-and-loop fastener system is attached to said electronic device, and a corresponding part is attached to said pocket or sleeve.

25. The apparatus of claim 1, wherein said means for releasably attaching said apparatus to said portable electronic device comprises a magnet.

26. The apparatus of claim 25, wherein said magnet is encased in at least one material that prevents direct contact of said magnet with said portable electronic device.

27. The apparatus of claim 1, wherein said means for releasably attaching said apparatus to said portable electronic device comprises at least one of a housing, a cover and a skin.

28. The apparatus of claim 27, further comprising a spine attached to said housing, said spine arranged to accept and grip at least a portion of said connector element.

29. The apparatus of claim 1, wherein said connector element is free to rotate about said means for releasably attaching said apparatus to said portable electronic device in at least one plane.

30. The apparatus of claim 1, wherein said optical magnifier comprises a Fresnel lens.

31. The apparatus of claim 1, wherein said optical magnifier comprises a convex lens.

32. The apparatus of claim 7, further comprising at least one of a pocket and a piece of elastic material arranged to store at least one of said stem and said magnifying element.

33. In a magnifier apparatus featuring an optical magnifying element to assist a human user in seeing a display of information,
(a) means for temporarily attaching said apparatus near said display in such a way that said user can position said optical magnifying element into a visual path between said display and at least one eye of said user; and
(b) a means for connecting said optical magnifying element to said temporary attachment means.
